(19) United States
(12) Patent Application Publication
(10) Pub. No.: US 2013/0045097 A1
(43) Pub. Date: Feb. 21, 2013

(54) ATTACHABLE GIB FOR SUPPORTING A TURBINE LOAD

(71) Applicants: Hemanth Kumar, Bangalore (IN); James Wilson Clark, Schenectady, NY (US)

(72) Inventors: Hemanth Kumar, Bangalore (IN); James Wilson Clark, Schenectady, NY (US)

(73) Assignee: GENERAL ELECTRIC COMPANY, Schenectady, NY (US)

(21) Appl. No.: 13/209,919

(22) Filed: Aug. 15, 2011

(51) Int. Cl. F01D 25/28; B23P 11/00

(52) U.S. Cl. 415/213.1; 29/889.2

(57) ABSTRACT

An apparatus for supporting a turbine section is disclosed. The apparatus includes a support structure and an attachable gib. The attachable gib has a first end configured to couple to the support structure and a second end configured to couple to the turbine section to transfer a load of the turbine section directly to the support structure to support the turbine.

### BACKGROUND OF THE INVENTION

The subject matter disclosed herein relates to a method and apparatus for bearing a load and is further related to an gib attachable to a support structure for bearing a load of a turbine section. A gib is a plain or notched, often wedge-shaped piece of wood or metal designed to hold parts of a machine or structure in place or provide a bearing surface. Typically, a turbine is secured at its low pressure (exhaust) end to a support structure at an extended portion of the support structure. The extended portion is a permanent feature of the support structure and therefore provides structural support to the turbine section. However, since the extended portion is a permanent feature of the support structure, turbines typically need to be constructed at least in part at an installation site to accommodate the shape of the support structure. This tends to slow the construction process. The present disclosure therefore provides a gib that can be attached to the support structure and the high or low pressure section of the turbine at an installation site of a turbine system.

### BRIEF DESCRIPTION OF THE INVENTION

According to one aspect of the invention, apparatus for supporting a turbine section includes a support structure and an attachable gib having a first end configured to couple to the support structure and a second end configured to couple to the turbine section to transfer a load of the turbine section directly to the support structure to support the turbine.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows a perspective view of an exemplary gib according to the present disclosure;

FIG. 2 shows a bottom view of the exemplary gib of FIG. 1;

FIG. 3 shows an exemplary support structure configured to mate with an exemplary gib to receive a load;

FIG. 4 shows an alternate support structure configured to mate with an exemplary gib to receive a load;

FIG. 5 shows the alternate support structure of FIG. 4 with an exemplary baseplate in place; and

FIG. 6 shows another exemplary support structure configured to mate with an exemplary gib to receive a load.

The detailed description explains embodiments of the invention, together with advantages and features, by way of example with reference to the drawings.

### DETAILED DESCRIPTION OF THE INVENTION

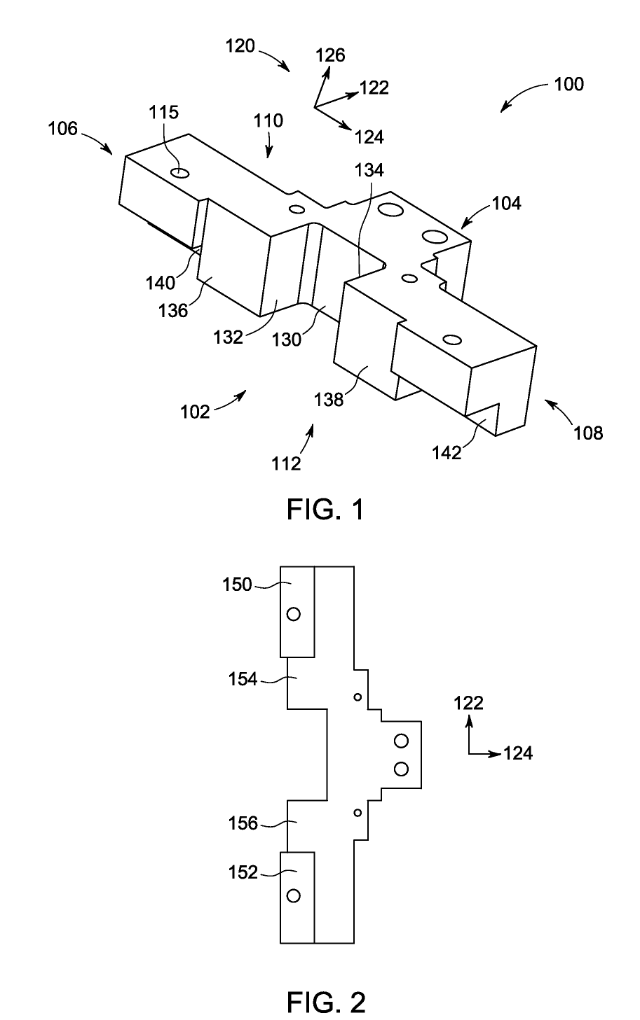

FIG. 1 shows a perspective view of an exemplary gib 100 according to the present disclosure. For the purposes of illustration, exemplary gib 100 is oriented in FIG. 1 along a gib-centered rectilinear coordinate system 120 that includes an axial direction 122, a transverse direction 124 and a vertical direction 126. Gib 100 includes a first end 102 and a second end 104 opposite the first end 102 along the axial direction. The first end 102 is typically configured to couple to a support structure. The support structure may include a baseplate, a post, a foundation, or a combination thereof Second end 104, in one embodiment, is configured to couple to a low pressure section of a turbine system such as a hood of the turbine system. Gib 100 also includes a first lateral portion 106 and a second lateral portion 108 opposed to the first lateral portion 106 along the transverse direction. One or more of the first lateral portion and the second lateral portion can be configured to couple to the support structure at the first end using one or more connecting devices, such as a bolt or screw. Gib 100 further includes a top end 110 and a bottom end 112 opposite the top end along the vertical direction. Vertically-aligned holes 115 are formed in gib 100 through which bolts or other suitable connecting devices can be inserted to secure the gib to the support structure.

In various embodiments, gib 100 is coupled to a support structure to transfer a load to the support structure. The load can be any of a vertical load, an axial load and/or a transverse load. An exemplary load includes a weight of the turbine system. Additional exemplary loads typically include loads due to seismic events, heat expansion, loss of last stage bucket, loads due to a bowed rotor which can be due to temperature variation, etc. These additional loads can introduce axial and transverse loads in addition to the vertical load from the weight of the steam turbine.

In one aspect, the gib is a removable gib that can be attached or secured between any two objects, such as the exemplary support structure and the exemplary steam turbine. The gib can be attached to the support structure and to the steam turbine at an installation location, enabling production of the support structure and turbine system separately and/or concurrently. In general, the gib couples to the support structure using a connecting device such as a bolt or screw. However, the gib is configured to transfer a load of the steam turbine directly to the support structure rather than via the connecting device between the gib and support structure. Direct transfer of a load refers to transferring a load through contacting faces, for example, contacting faces of the gib and the support structure. Various examples are discussed below.

First end 102 of gib 100 includes one or more faces for providing contact with a baseplate portion of the support structure to transfer a load to the baseplate. The exemplary gib 100 includes faces 130, 132, 134, 136, 138 140 and 142. Support structure can include faces complementary to faces 130, 132, 134, 136, 138, 140 and 142 which are in direct contact with the faces when the gib is mated to the support structure to directly receive loads from the gib. Faces 130, 132 and 134 are formed at a recessed area or notch at the first end 102. Face 130 is axially directed toward first end 102 and faces 132 and 134 are transversely directed toward second lateral portion 108 and first lateral portion 106, respectively. As discussed herein an “axially directed” face refers to a face having a normal aligned along the axial direction 122 of the coordinate system 120. Terms “transversely directed” and “vertically directed” are similarly defined. Faces 136, 138, 140 and 142 of gib 100 are axially directed toward first end 102. Faces 140 and 142 are recessed from faces 136 and 138, respectively. Axially directed faces 130, 136, 138, 140 and 142 are configured to transfer an axial load to the support structure. Transversely directed faces 132 and 134 are configured to transfer a transverse load to the support structure.

FIG. 2 shows a bottom view of gib 100 of FIG. 1. The bottom view shows bottom end 112. Faces 150 and 152 are recessed from the bottom end 112 and vertically directed toward the bottom end 112. When the gib is mated with the support structure, faces 150 and 152 transfer vertical load to the support structure. Vertically directed faces 154 and 156 at the bottom end 112 can be coupled to the support structure to transfer a vertical load.

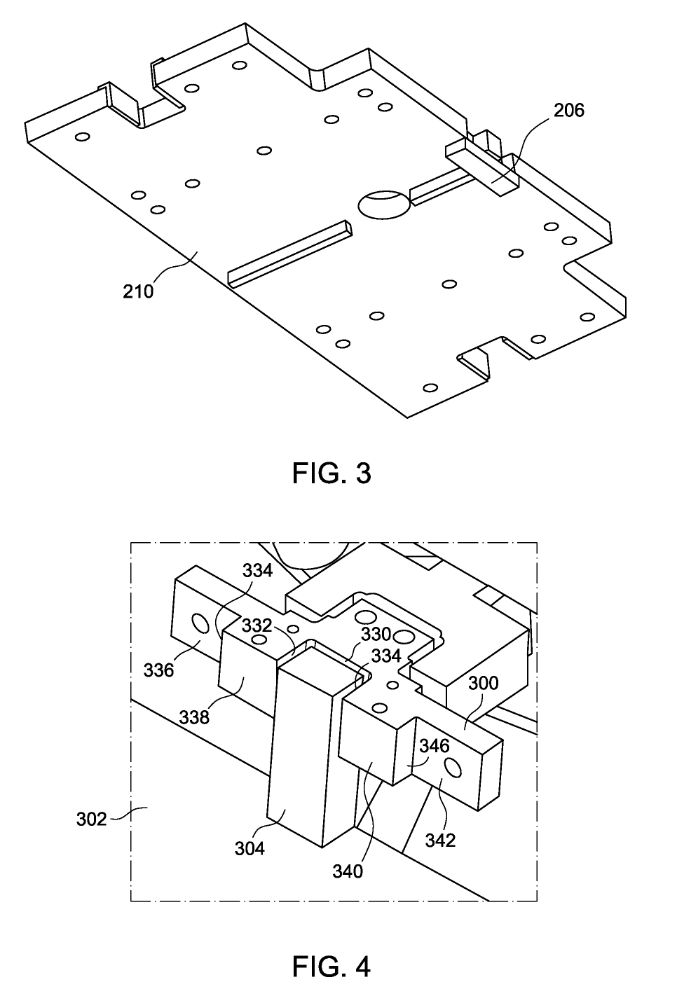

FIG. 3 shows an exemplary support structure 200 configured to mate with a gib such as exemplary gib 100 and to receive a load from the gib. Support structure 200 includes a baseplate portion 210 having various recessed areas 202 and 204 to receive gib 100 and a gib support 206 which in one embodiment can be attached to bottom end 112 of baseplate 210. In various embodiments, gib support 206 provides a base to receive a vertical load of gib 100.

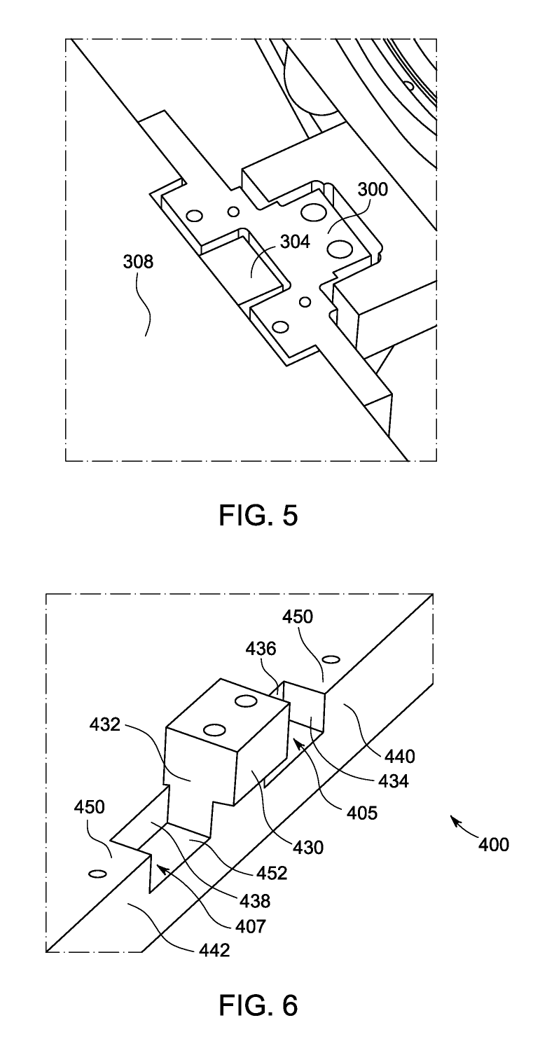

FIG. 4 shows an alternate support structure configured to mate with gib 300 to receive a load. Support structure includes a foundation 302 having a post 304 extending from the foundation. Gib 300 is configured to couple to post 304 at faces 330, 332 and 334. Face 330 transfers an axial load to post 304 and faces 332 and 334 transfer transverse loads to post 304. FIG. 5 shows the alternate support structure of FIG. 4 with an exemplary baseplate 306 in place. As shown in FIG. 5, baseplate 306 is configured to couple to gib 300 to receive various axial loads from the gib through faces 336, 338, 340 and 342. In addition, transversely directed faces 344 and 346 couple to complementary faces of the baseplate to transfer transverse loads to the baseplate.

FIG. 6 shows another exemplary support structure configured to mate with an exemplary gib to receive a load. Baseplate 400 includes recessed areas 405 and 407. Baseplate 400 therefore has axially directed faces 430, 436, 438, 440 and 442 for coupling to complementary axially directed faces of the gib when mated to the gib. Faces 430, 436, 438, 440 and 442 therefore receive an axial load from the gib. The exemplary support structure also includes transversely directed faces 432 and 434 configured to couple to complementary transversely directed faces of the when mated to the gib. Faces 432 and 434 therefore receive a transverse load from the gib. Exemplary vertically directed faces 450 and 452 are configured to couple to vertically directed faces of the exemplary gib to receive a vertical load.

Therefore, in one aspect, the present disclosure provides an apparatus for supporting a turbine section, including a support structure; and an attachable gib having a first end configured to couple to the support structure and a second end configured to couple to the turbine section to transfer a load of the turbine section directly to the support structure to support the turbine. The support structure in one embodiment includes a baseplate and the gib is further configured to transfer at least one of a transverse load and an axial load directly to the baseplate. In another embodiment, the baseplate has a gib support coupled thereto and the gib is configured to transfer a vertical load to the gib support. In yet another embodiment, the support structure includes a baseplate and a foundation and the gib is configured to transfer a transverse load directly to the foundation and an axial load directly to the foundation and the baseplate. In one embodiment, the gib includes a notch having an axially directed surface and at least one transversely directed surface, wherein the axially directed surface is configured to transfer an axial load to the support structure and the at least one transversely directed surface is configured to transfer a transverse load to the support structure. The first end of the gib further can include recessed axially directed surfaces configured to transfer an axial load to the support structure. In various embodiments, at least one connecting device is used to couple the gib to the support structure. Typically, the turbine section is a low pressure end of a turbine. However, the methods of the present disclosure can also be applied to a high pressure section of the turbine.

In another aspect, the present disclosure provides a method of supporting a generator, including: assembling a turbine section of the generator; providing a support structure adjacent the turbine section; coupling a gib to the support structure at a first end of the gib; and coupling a second end of the gib to the turbine section to transfer a load of the turbine section directly to the support structure. The support structure in one embodiment includes a baseplate, further comprising transferring at least one of a transverse load and an axial load from the gib directly to the baseplate. In another embodiment, a gib support is coupled to the baseplate and a vertical load is transferred directly to the gib support. In an embodiment wherein the support structure includes a baseplate and a foundation, a transverse load is transferred directly to the foundation and an axial load is transferred directly to the foundation and the baseplate. In an embodiment wherein the gib comprises a notch including an axially directed surface and at least one transversely directed surface, an axial load is transferred to the support structure via the axially directed surface and a transverse load is transferred to the support structure via the at least one transversely directed surface. In another embodiment an axial load of the turbine section is transferred to the support structure via recessed axially directed surfaces at the first end of the gib. The gib can be coupled to the support structure using at least one connecting device. The second end of the gib is typically coupled to a low pressure end of the turbine section. In one embodiment, the turbine section is assembled at a first location and is coupled to the gib at a second location. The second location is typically an installation location of the generator.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An apparatus for supporting a turbine section, comprising:
a support structure; and
an attachable gib having a first end configured to couple to the support structure and a second end configured to couple to the turbine to transfer a load of the turbine section directly to the support structure to support the turbine section.

2. The apparatus of claim 1, wherein the support structure includes a baseplate and the gib is further configured to transfer at least one of a transverse load and an axial load directly to the baseplate.

3. The apparatus of claim 2 further comprising a gib support coupled to the baseplate, wherein the gib is further configured to transfer a vertical load to the gib support.

4. The apparatus of claim 1, wherein the support structure includes a baseplate and a foundation, the gib further configured to transfer a transverse load directly to the foundation and an axial load directly to the foundation and the baseplate.

5. The apparatus of claim 1, wherein the gib comprises a notch including an axially directed surface and at least one transversely directed surface, wherein the axially directed surface is configured to transfer an axial load to the support structure and the at least one transversely directed surface is configured to transfer a transverse load to the support structure.

6. The apparatus of claim 1 wherein the first end of the gib further comprises recessed axially directed surfaces configured to transfer an axial load to the support structure.

7. The apparatus of claim 1 further comprising at least one connecting device configured to couple the gib to the support structure.

8. The apparatus of claim 1, wherein the turbine section is a low pressure end of a turbine.

9. A method of supporting a generator, comprising:
assembling a turbine section of the generator;
providing a support structure adjacent the turbine section;
coupling a gib to the support structure at a first end of the gib; and
coupling a second end of the gib to the turbine section to transfer a load of the turbine section directly to the support structure.

10. The method of claim 9, wherein the support structure includes a baseplate, further comprising transferring at least one of a transverse load and an axial load from the gib directly to the baseplate.

11. The method of claim 10, wherein a gib support is coupled to the baseplate, further comprising transferring a vertical load to the gib support.

12. The method of claim 9, wherein the support structure includes a baseplate and a foundation, further comprising transferring a transverse load directly to the foundation and an axial load directly to the foundation and the baseplate.

13. The method of claim 9, wherein the gib comprises a notch including an axially directed surface and at least one transversely directed surface, further comprising transferring an axial load to the support structure via the axially directed surface and transferring a transverse load to the support structure via the at least one transversely directed surface.

14. The method of claim 9 further comprising transferring an axial load of the turbine section to the support structure via recessed axially directed surfaces at the first end of the gib.

15. The method of claim 9 further comprising coupling the gib to the support structure using at least one connecting device.

16. The method of claim 9 further comprising coupling second end of the gib to a low pressure end of the turbine section.

17. The method of claim 9 further comprising assembling the turbine section at a first location and coupling the gib to the turbine section at a second location.

18. The method of claim 17, wherein the second location is an installation location of the generator.
